(19) United States
(12) Patent Application Publication
(10) Pub. No.: US 2017/0117978 A1
(43) Pub. Date: Apr. 27, 2017

(54) METHOD FOR SELECTING TTL FOR A MESH NETWORK

(71) Applicant: MEDIATEK INC., Hsin-Chu (TW)

(72) Inventor: Li-Chun KO, Taipei City (TW)

(21) Appl. No.: 15/335,246

(22) Filed: Oct. 26, 2016

Related U.S. Application Data
(60) Provisional application No. 62/246,778, filed on Oct. 27, 2015.

(51) Int. Cl. H04H 20/93; H04L 12/801; H04L 5/00; H04L 12/721; H04L 12/933; H04L 29/06

(52) U.S. Cl. CPC H04H 20/93; H04L 49/1584; H04L 69/22; H04L 5/0055; H04L 45/32; H04L 47/35

(57) ABSTRACT

A method for a wireless mesh network is provided. The wireless mesh network comprises a first node and a second node. The method comprises the step of: broadcasting a packet by the first node, wherein the packet comprises an indicator of time to live (TTL) and an initial TTL. The second node receives the packet, wherein the received packet includes an adjusted TTL and the initial TTL. The second node then determines a new TTL by the second node according to the adjusted TTL and the initial TTL.

### CROSS REFERENCE TO RELATED APPLICATIONS

This Application claims priority of U.S. Provisional Application No. 62/246,778, filed on Oct. 27, 2015, the entirety of which is incorporated by reference herein.

### BACKGROUND OF THE APPLICATION

Field of the Application

The application relates generally to the wireless communications, and more particularly, to methods for selecting a time to live in a wireless mesh network that supports flooding.

Description of the Related Art

The use of wireless mesh networks has increased in recent years to improve the range of wireless communications. A wireless mesh network typically includes a plurality of wireless nodes that communicate with one another to propagate data packets. For example, in a multi-hop wireless mesh network, a data packet is propagated from a source node, or an originating node, to a destination node by “hopping” from one wireless node to another until the data packet reaches the destination node. As such, each node in a wireless mesh network operates as both a receiver and a transmitter to communicate data packets between intermediate nodes.

Flooding is a common network operation in which a data packet is sent by one node to every other node in a wireless mesh network. Each wireless node that receives that data packet, and hasn't received it before, forwards or retransmits the received data packet to every other known neighboring node except for the originating node. In order to restrict the packets floods, each packet includes a value, such as a Time to Live (TTL) value, to limit the number of times a packet can be relayed. For example, when a wireless node receives a data packet, the wireless node checks the TTL value carried in the packet. If the carried TTL equals to 1, the wireless node does not forward or retransmit the packet. Contrarily, if the carried TTL equals to 2 or a number larger than 2, the wireless node forwards or retransmits the packet to every other known neighboring node except for the originating node. Therefore, the TTL value indicates a number of times a packet can relayed. To efficiently forward a packet, the TTL value should be selected large enough to reach the destination node. However, on the other hand, the TTL value cannot be too large to result in lots of unnecessary overhead in the wireless mesh network. Hence, there's a need to develop a method to select an efficient TTL value for a mesh network.

### BRIEF SUMMARY OF THE APPLICATION

In a first aspect of the application, a method for a wireless mesh network is provided. The wireless mesh network comprises a first node and a second node. The method comprises the steps of broadcasting a packet by the first node, wherein the packet comprises an indicator of time to live (TTL) and an initial TTL, receiving the packet by the second node, wherein the received packet includes an adjusted TTL and the initial TTL, and determining a new TTL by the second node according to the adjusted TTL and the initial TTL.

In a second aspect of the application, a method for a node in a wireless mesh network is provided. The method comprises the steps of, broadcasting a packet by the node, wherein the packet comprises an indicator of time to live (TTL), receiving a response by the node, wherein the response includes an adjusted TTL, and determining a new TTL by the node according to the adjusted TTL.

In a third aspect of the application, a method for a wireless mesh network is provided. The wireless mesh network comprises a first node and a second node. The method comprises the steps of, broadcasting a first packet by the first node, wherein the packet comprises a first time to live (TTL), responding a second packet by the second node, wherein the second packet comprises an adjusted first TTL and a second TTL, and sending a third packet by the first node, wherein the packet comprises an adjusted second TTL. The first node determines a new TTL according to the adjusted first TTL and a first initial TTL, and the second node determines a new TTL according to the adjusted second TTL and a second initial TTL.

Other aspects and features of the application will become apparent to those with ordinary skill in the art upon review of the following descriptions of specific embodiments of the wireless communication devices and methods for propagating a data packet in a wireless mesh network.

### BRIEF DESCRIPTION OF THE DRAWINGS

The application can be more fully understood by reading the subsequent detailed description and examples with references made to the accompanying drawings, wherein:

FIG. 1 is a block diagram illustrating a wireless mesh network according to an embodiment of the application;

FIG. 2 is a block diagram illustrating a wireless mesh network according to an embodiment of the application;

FIG. 3 is a block diagram illustrating a wireless mesh network according to an embodiment of the application;

FIG. 4 is a communication between two nodes in a wireless mesh network according to an embodiment of the application;

FIG. 5 is a block diagram illustrating a wireless mesh network according to an embodiment of the application.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The Bluetooth specifications are used to teach the spirit of the application, and the application is not limited thereto.

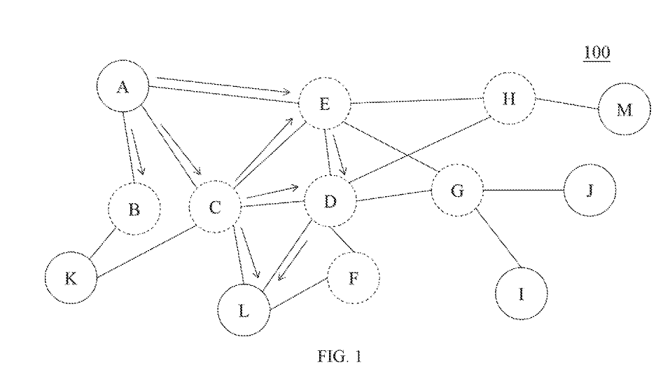

FIG. 1 is a block diagram illustrating delivery of a data packet in a wireless mesh network 100 according to an embodiment of the application. The wireless mesh network 100 includes a plurality of wireless communications devices A to L, wherein the wireless communications devices I, J, K, L, M are edge nodes which do not forward data packets. Wireless communication devices B, C, D, E, F, G, and H are relay nodes that have the ability to forward data packets using a flooding-based propagation mechanism.

In a wireless mesh network 100 shown in FIG. 1, an edge node usually establishes a friendship with at least one neighboring node to act as a neighboring relay. This friend relay stores all incoming packets for the edge node while the edge node is in sleep mode and then forwards the stored packets to the edge node when the edge node wakes up. Therefore, for the edge node M shown in FIG. 1, the wireless communication device B can be established as a friend relay node to edge node M.

When node A transmits a packet that is destined to node L, node A broadcasts the packet to node B, node C, and node E. Inside the packet, a Time to Live (TTL) value is included therein. When node C receives the packet, node C checks the TTL value. If, for example, the TTL value included in the packet is set to 10, node C finds the TTL value to be larger than or equal to 2, node C thus forwards the packet and reduces the TTL value by 1 to node L. Therefore, node L receives a packet from node C with a TTL value of 9. Since node C can be established as a friend relay of node L, node C may store the packet while node L is in sleep mode and then forward the packet to node L when node L wakes up.

For another node E that also receives the packet from node A, node E also checks the TTL value inside the received packet and then forwards the packet to node D with a reduced TTL value. Node D hence receives the packet with a TTL value of 9 and decides to keep forwarding the packet to node L. As one can see from the aforementioned example, the relay nodes in a wireless mesh network would keep forwarding the packet until the packet reaches the destination, or until the TTL value becomes 2. So the present application provides efficient method to determine a reasonable TTL.

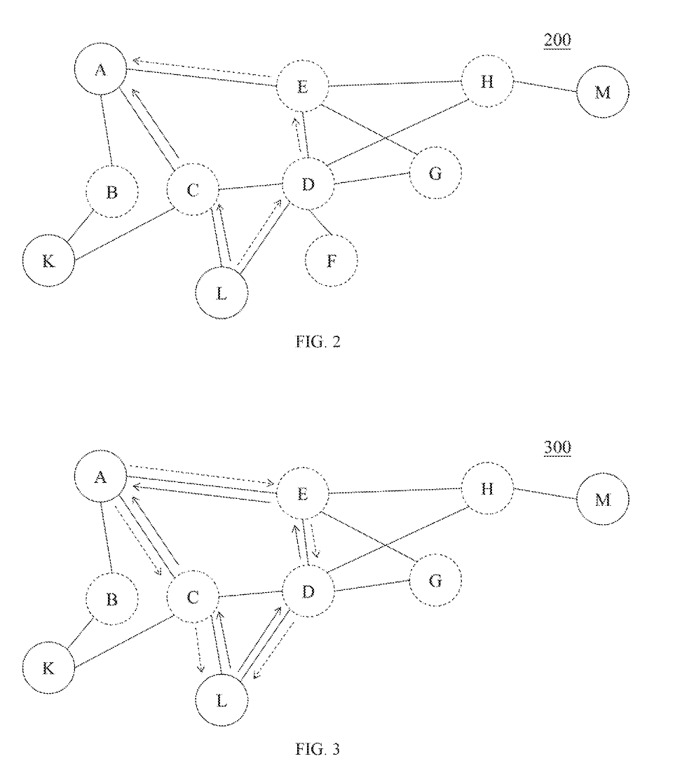

Please refer to FIG. 2 which illustrates a wireless mesh network 200 according to an embodiment of the present application. The wireless mesh network 200 comprises a plurality of wireless communication devices and each of these communication devices becomes a “node” in the wireless mesh network 200. Wireless communication devices K and M act as edge nodes in the wireless mesh network 20 which do not forward data packets. Wireless communication devices B, C, D, E, F, G, and H act as relay nodes that have the ability to forward data packets using a flooding-based propagation mechanism in the wireless mesh network 200. According to an embodiment of the present application, when a new wireless communication device L plans to join the wireless mesh network 200, the wireless communication device L becomes a node L in the wireless mesh network 200. Node L can be a node that newly joins the mesh network or a node re-joins the mesh network after a disconnection. Node L sends a message that comprises a Time to Live (TTL) value and initial TTL information. This message is sent to the nodes in the mesh network 20 through broadcasting.

The initial TTL comprised in the message can be any number decided by node L. In this example, TTL is set as 10. However, the initial TTL can be set as any applicable numbers. As shown in FIG. 2, node L is wirelessly connected to node C and node D when node L joins the mesh network 200. Therefore, the message broadcasted by node L is first sent to node C and node D. When node C receives the message, node C checks whether the TTL meets a certain criteria that allows node C to forward the message. For example, node C checks the TTL included in the message to see whether the TTL is larger than or equal 2. Since the TTL in the message is the initial TTL that is set as 10 in this embodiment, node C decides to forward this message to neighboring nodes. Therefore, node C reduces the TTL in the message to 9 when the message is forwarded to node A. Node A thus receives the message from node C that comprises a TTL of 9 and an initial TTL of 10.

Regarding the other node D that also receives the message from node L, node D also performs a similar operation to decide whether to forward the message as node C does. Node D then forwards the message to node E and reduces the TTL to 9. Node E also checks the TTL and decides to forward the message to node A with a further reduced TTL. Therefore, node A receives another copy of the message originated from node L from node E. But the message forwarded by node E now comprises a TTL of 7 and an initial TTL of 10.

After receiving the two copies of the message from two different paths, one is through nodes L-C-A and the other path is through nodes L-D-E-A, node A can compare the initial TTL, 10, with the two TTL values, 7 and 8, obtained though different paths. Node A then concludes that a reasonable TTL for sending a packet from node A to node L would be 2 or 3. Therefore, when node A acts as a source node and has a packet that is destined to node L, node A can set TTL as 2 or 3 to prevent unnecessary overhead and flooding to the wireless mesh network 200 but at the same time make sure that node L can successfully receive the packet.

In addition to the aforementioned method, the present application provides another two way ping method to decide a reasonable TTL. Please refer to FIG. 3 which illustrates a wireless mesh network 300 according to an embodiment of the present application. The wireless mesh network 300 comprises a plurality of wireless communication devices and each of these communication devices becomes a “node” in the wireless mesh network 300. Wireless communication devices K, L and M act as edge nodes in the wireless mesh network 300 which do not forward data packets. Wireless communication devices B, C, D, E, G, and H act as relay nodes that have the ability to forward data packets using a flooding-based propagation mechanism in the wireless mesh network 300.

In order to determine a reasonable TTL between the source node A and a wireless communication device L which acts as a target node L, node L can send a ping message to node A. In the ping message, node L includes a TTL as 10. Please note that this value is exemplary and can be set as any applicable number. This TTL can be set the same as an initial TTL. However, only the TTL is necessary in the message. According to another embodiment, the initial TTL may not be carried in the message. The ping message is transmitted from node L to node A through different paths. Two paths are taken as illustrated examples, one is through node C and the other path is through node D and node E. Therefore, when node A receives the ping message forwarded from node C, the TTL carried in the ping message is 8. Similarly, the ping message that node A receives from node E has a TTL of 7.

In response to the ping message, node A then sends a response to node L. In the response, node A reported the TTL in the received ping message. In an example, node A reported TTL to be the smaller of the received TTL values, which is 7. According to TTL received by node A and the initial TTL, node L can determine a reasonable TTL to transmit a packet/message/response from node L to node A according to the received TTL at node A and the initial TTL.

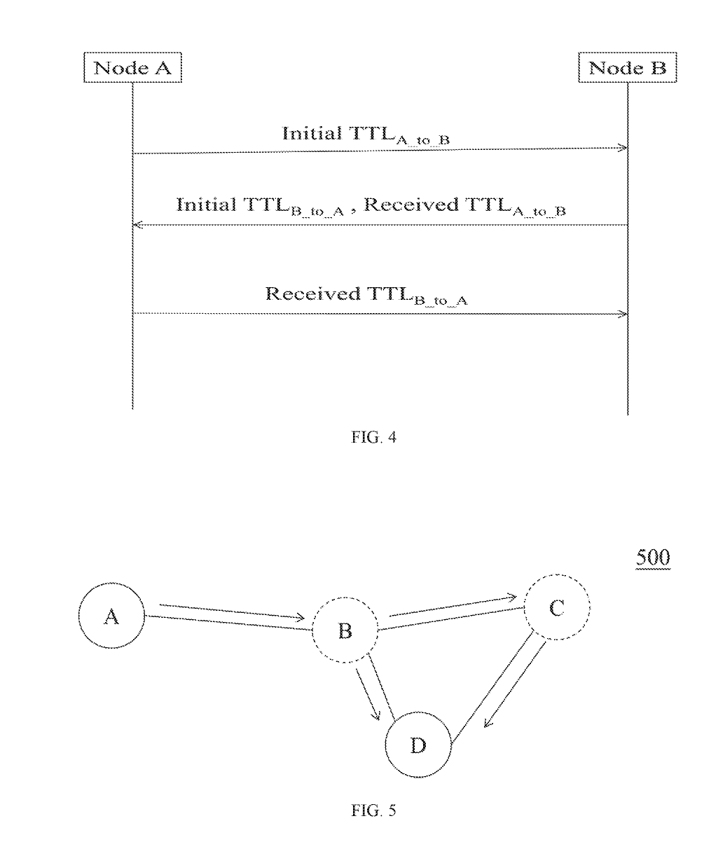

According to another embodiment of the present invention, a three-way ping can be used in a wireless mesh network to determine a reasonable TTL. Please refer to FIG. 4 which illustrates a communication between two nodes in a wireless mesh network. Here node A and node B are nodes within a wireless mesh network. Node A first sends a packet to node B. The packet includes an initial TTL_{A}_{_}ₜₒ_{_}_{B} which indicates an initial TTL from node A to node B. This packet is relayed through different paths and different nodes in the wireless mesh network. When node B receives the packet that includes the initial TTL_{A}_{_}ₜₒ_{_}_{B}, node B gets different TTL values that are forwarded by the different nodes. In response to the packet, node B sends a second packet to node A. In the second packet, node B records an initial TTL_{B}_{_}ₜₒ_{_{——}}_{A} along with the received TTL_{A}_{_}ₜₒ_{_}_{B} in the second packet, wherein the received TTL_{A}_{_}ₜₒ_{_}_{B} is determined based on different TTL values.

After forwarding and relaying by the different nodes in the wireless mesh network, node A receives the second packet. From the received second packet, node A obtains the received TTL_{A}_{_}ₜₒ_{_}_{B} and a received TTL value. By comparing the initial TTL_{A}_{_}ₜₒ_{_}_{B} , and the received TTL_{A}_{_}ₜₒ_{_}_{B}, node A can determine a reasonable TTL for sending a packet from node A to node B.

Afterwards, node A sends a third packet to node B. Within the third packet, node A includes the received TTL_{B}_{_}ₜₒ_{_}_{A} to node B. Therefore, when node B receives the third packet that is forwarded by the nodes in the wireless mesh network, node B can determine a reasonable TTL for sending a packet from node B to node A according to the initial TTL_{B}_{_}ₜₒ_{_}_{A} and the received TTL_{B}_{_}ₜₒ_{_}_{A} . Since the paths that forward a packet from node A to node B may not be the same as the paths that forward a packet from node B to node A, the present application provides a method to determine the two TTL values in both direction with a three way ping method. With the three way ping method, unnecessary overhead and flooding to the wireless mesh network can be therefore prevented.

Please refer to FIG. 5 which illustrates a wireless mesh network 500 according to an embodiment of the present application. Node A in FIG. 5 is a source node that transmits packets to a target node D. Within the packet sent by node A, an initial TTL equals to 5 is included. Please note that this is exemplary and the initial TTL can set to any applicable number. After forwarding the relaying the packet through different nodes and paths, node D receives a first copy of the packet from node B and a second copy of the packet from node C. Within the packet that is forwarded from node B, which is forwarded through a path of A-B-D, a received TTL of 4 is included. On the other hand, the packet that is forwarded from node C, which is forwarded through a path of A-B-C-D, includes a received TTL of 3. In order to facilitate the selection of an efficient TTL, the edge node D needs to respond the received TTL back to the source node A. According to an embodiment of the present application, node D can piggybacks the received TTL of 4 or 3 with an acknowledgement (ACK) packet. The ACK packet is usually sent to notify the sender of a packet that the packet is received by the target node. Therefore, there's no need for the target node to send a separate packet to the source node to notify the received TTL. By piggybacking the received TTL to an ACK packet, unnecessary overhead and flooding can be reduced.

According to another method of the present application, instead of directly reporting the received TTL to the source node, the target/destination node can report to the source node whether the TTL should be increased, decreased for kept the same. Please again refer to FIG. 5 which illustrates a wireless mesh network 500 according to an embodiment of the present application. In this wireless mesh network 500, node A acts as a source node, and node D acts as a target or a destination node. Before transmission, node A and node D have a pre-negotiated a target received TTL, for example, as 2. When the source node A transmits a packet to node D, an initial TTL of 5 is carried within the packet. After forwarding through a first path A-B-D, node D receives the packet with a received TTL of 4. Another copy of the packet is forwarded through a second path A-B-C-D which results in a received TTL of 3 when node D receives the second copy of the packet. By comparing the two received TTL and the pre-negotiated received TTL, node D sends a message back to the source node A with a request or suggestion to decrease the TTL in order to make the received TTL as close to the pre-negotiated received TTL as possible. By doing so, the target node can indicate if the TTL setting should be adjusted. Whereas in other approaches the TTL is decided by the originating device according the received TTL reported by the other node. The message can be piggybacked to an ACK as that in the aforementioned embodiment.

Please again refer to FIG. 5. Node A and node D have pre-negotiated a target received TTL of 2. When node A transmits a packet to node D, an initial TTL of 4 is carried with the packet. This time, node D would receive two copies of the packet through the two different paths with two different received TTL of 3 and 2. In this example, since one of the received TTL is the same as the pre-negotiated received TTL, which is 2. Node D sends a response to the source node A and request or suggest node A to keep using the same TTL. The response can be piggybacked to an ACK as that in the aforementioned embodiment.

In another example of the present application, please again refer to FIG. 5. Node A and node D have pre-negotiated a target received TTL of 2. When node A transmits a packet to node D, an initial TTL of 3 is carried with the packet. After forwarding through different paths, two different received TTL of 2 and 1 are received by node D. By comparing the received TTLs with the pre-negotiated received TTL, node D found that this initial TTL of 3 will result in a received TTL lower than the pre-negotiated TTL (1<2). Therefore, Node D sends a response to the source node A and request or suggest node A to increase the TTL. The response can be piggybacked to an ACK as that in the aforementioned embodiment.

According to another embodiment of the present invention, in order to further reduce traffic overhead, the TTL feedback can only be piggybacked with an ACK under specific circumstances. For example, only to piggyback TTL feedback when the received TTL is not 1. Or, only to piggyback TTL feedback when the received TTL is more than 2 or more than a pre-negotiated TTL. Or, only to piggyback TTL feedback when the received TTL is less than 2 or less than a pre-negotiated TTL. Or, only to piggyback TTL feedback whenever a certain number of packets are transmitted, for example 1000 packets. Or, only to piggyback TTL feedback after a predetermined period of time, for example 60 seconds.

In view of the forgoing embodiments, it will be appreciated that the present application provides methods to more efficiently determine a TTL in wireless mesh networks, by determining an initial TTL. Therefore, a lower traffic overhead can be achieved.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

What is claimed is:

1. A method for a wireless mesh network, wherein the wireless mesh network comprises a first node and a second node, the method comprising:
broadcasting a packet by the first node, wherein the packet comprises an indicator of time to live (TTL) and an initial TTL;
receiving the packet by the second node, wherein the received packet includes an adjusted TTL and the initial TTL; and
determining a new TTL by the second node according to the adjusted TTL and the initial TTL.

2. The method as claimed in claim 1, wherein the step of receiving the packet by the second node comprises:
receiving a first copy of the packet through a first path; and
receiving a second copy of the packet through a second path,
wherein the first copy of the packet comprises a first adjusted TTL and the second copy of the packet comprises a second adjusted TTL.

3. The method as claimed in claim 1, wherein each node on the first path and the second path forwards the packet to a next node with a reduced TTL

4. The method as claimed in claim 1, wherein the response is an ACK packet and the TTL information is piggybacked to the ACK packet.

5. The method as claimed in claim 1, wherein the TTL information in the response comprises a message to increase, to reduce or the keep the TTL.

6. The method as claimed in claim 1, wherein the TTL information in the response comprises a suggested TTL.

7. The method as claimed in claim 1, wherein wireless mesh network is a flooding-based propagation mesh network.

8. The method as claimed in claim 1, wherein wireless mesh network is a Bluetooth mesh network.

9. A method for a node in a wireless mesh network, the method comprising:
broadcasting a packet by the node, wherein the packet comprises an indicator of time to live (TTL);
receiving a response by the node, wherein the response includes an adjusted TTL; and
determining a new TTL by the node according to the adjusted TTL.

10. The method as claimed in claim 9, wherein the step of determining a new TTL comprises, comparing the adjusted TTL with an initial TTL to determine the new TTL.

11. The method as claimed in claim 9, wherein the adjusted TTL is adjusted by a plurality of nodes along a delivery of the packet to a peer node.

12. The method as claimed in claim 9, wherein the response is an ACK packet and the TTL information is piggybacked to the ACK packet.

13. The method as claimed in claim 9, wherein wireless mesh network is a flooding-based propagation mesh network.

14. The method as claimed in claim 9, wherein wireless mesh network is a Bluetooth mesh network.

15. A method for a wireless mesh network, wherein the wireless mesh network comprises a first node and a second node, the method comprising:
broadcasting a first packet by the first node, wherein the packet comprises a first time to live (TTL);
responding a second packet by the second node, wherein the second packet comprises an adjusted first TTL and a second TTL; and
sending a third packet by the first node, wherein the packet comprises an adjusted second TTL;
wherein the first node determines a new TTL according to the adjusted first TTL and a first initial TTL, and the second node determines a new TTL according to the adjusted second TTL and a second initial TTL.

16. The method as claimed in claim 15, wherein wireless mesh network is a flooding-based propagation mesh network.

17. The method as claimed in claim 15 wherein wireless mesh network is a Bluetooth mesh network.

18. The method as claimed in claim 15, wherein the second packet is a ACK packet and the adjusted first TTL is piggybacked to the ACK packet.

19. The method as claimed in claim 15, wherein the adjusted first TTL is adjusted by a plurality of nodes along a delivery of the first packet.
